(19) United States
(12) Patent Application Publication
(10) Pub. No.: US 2008/0215180 A1
(43) Pub. Date: Sep. 4, 2008

(54) ARRANGEMENT FOR DYNAMIC LEAN REPLENISHMENT AND METHODS THEREFOR

(76) Inventor: Rao Kota, Cupertino, CA (US)

Correspondence Address: IPSG, P.C., P.O. BOX 700640, SAN JOSE, CA, 95170, US

(21) Appl. No.: 11/681,718

(22) Filed: Mar. 2, 2007

(51) Int. Cl. G06F 17/00

(52) U.S. Cl. 700/236; 700/115; 700/51

(57) ABSTRACT

A dynamic lean replenishment method for handling inventory management is provided. The method includes performing analysis to determine a projected inventory stock. The analysis is performed in accordance with at least one of a synchronous mode and an asynchronous mode. In the synchronous mode, a computer is configured to perform the analysis to determine the projected inventory stock after consumption has occurred. The consumption is deemed to have occurred when a first bin of a plurality of bins is consumed and changes from a bin state of on-hand to the bin state of empty. In the asynchronous mode, the computer is configured to perform the analysis to determine the projected inventory stock after a preset time interval. The method also includes comparing the projected inventory stock to a safety stock to determine replenishment.

### BACKGROUND OF THE INVENTION

In today's business world, inventory management plays an important role in a company's efficiency and profitability. In a company, the high inventory levels (e.g., raw material, work-in progress materials, etc.) can significantly increase carrying costs and parts handling costs. In inventory management, a company tries to maintain the lowest level of inventory while preventing inventory stock-outs. As discussed herein, a stock-out refers to the situation in which insufficient inventories are available resulting in delayed production of one or more customer orders. Thus, the ability for a company to determine when material replenishment may need to occur is essential in maintaining a low level of inventory while preventing stock-outs.

An inventory system that has been implemented by companies to address material replenishment is the Kanban system. In the Kanban system, a pull based system is implemented in which a supplier replenishes material when a consumer sends a replenishment signal. Typically, materials are stored in bins or standard lot sizes in a Kanban system. As a bin is consumed, a signal is sent to the supplier to replenish the bin. Upon receiving the signal, the supplier sends the materials to the consumer.

To facilitate discussion, FIG. 1 shows a simple flow chart diagram illustrating the method for implementing a Kanban system.

At a first step 102, a bin may have a state of on-hand. In an example, the bin is full of materials and no consumption has occurred.

At a next step 104, the bin has been consumed and the bin state has changed to empty. Generally, consumption is defined as either a newly opened box or an emptied box. In an opened box situation, the bin may have been opened; however, no actual consumption may have occurred. In an emptied box situation, the material stored in the bin has been fully consumed. Regardless as how consumption is defined by a company, a consumed bin changes the state of the bin to empty.

At a next step 106, a signal has been sent to the supplier. In an example, when the bin state is empty, a signal (e.g., electronic signal) may be sent to the supplier to replenish the consumed bin. In the traditional Kanban system, the amount of replenishment is usually equal to the amount of the immediate consumption. In an example, when a bin is consumed, a signal may be sent to replenish one bin. Once the signal has been sent, the bin state may change to on-order.

At a next step 108, the supplier receives the request from the consumer. Since a Kanban system may be applied internally as well as externally, a supplier may either be an outside vendor or an internal vendor. In an example, an outside vendor may be a supplier that provides one or more parts/services for the consumer and is not part of the company. In another example, an internal vendor may be a supplier that is part of the company and is located upstream from the consumer, and is responsible for providing one or more parts/service downstream.

At a next step 110, the supplier may handle the request from the consumer. The supplier may either procure the inventories, manufacture the inventories, or provide a service (e.g., paint a car). The handling of the request may be dependent upon pre-arranged terms. The consumer and the supplier may have established policies on how a request may be handled. In an example, if a request is sent before noon, then the supplier may handle the request within the day. In another example, if a request is received on Friday, the supplier may not handle the request until the next business day (e.g., Monday).

At step 112, the supplier sends the consumer the requested materials. In an example, for an outside supplier, the supplier may ship the materials to the consumer.

At step 114, the consumer may receive the materials and the bin may be filled. Once the bin has been filled, the bin state may be changed from on-order back to on-hand.

The method described in steps 102 to 114 is an iterative method that may be performed as bins are consumed and replenished.

FIG. 2 is a simple diagram illustrating the different bin states in a traditional Kanban system.

At a state 200, a bin state is on-hand. In an example, the bin is filled with materials and no consumption has occurred.

At a state 202, the bin state is empty. As aforementioned, an empty state may occur when the bin is either in an opened box (opened but not consumed) or an emptied (opened and has been consumed) box situation.

At a state 204, the bin state is on-order. An on-order state may occur when the bin has been consumed and a replenishment signal has been sent to a supplier.

The transition from states 202 to 204 may occur without delay. In an example, once a bin state has changed to empty, a replenishment signal may be sent immediately to a supplier and the bin state is immediately be changed to on-order.

Since the replenishment loop described above has a one-to-one replacement ratio, a company may be unable to handle an unexpected spike in demand and/or may have high inventory carrying costs when demand unexpectedly declines. To address fluctuations, a company may maintain safety stock in an attempt to absorb the changing demands and setting the correct safety stock is very important.

The traditional Kanban system is an excellent inventory management system if actual demand rates are constant and that demand rate is the same rate that has been utilized to calculate the replenishment loop size. Realistically, the ability to project an accurate demand rate may be difficult. In an example, if demands changes and stabilizes and the safety stock has not been adjusted, a traditional Kanban system (e.g., replenishment loop with the safety stock) may be insufficient to address the fluctuating demands. In an example, demand may have increased and stabilized resulting in safety stock being utilized to address the increase in demand. Over time, the inventory level may drop and safety stock may be insufficient to protect against unexpected spikes resulting in stock-out. In another example, demand may have decreased and stabilized resulting in fewer inventories being utilized. Over time, the inventory level may become elevated and excess inventories may be carried resulting in high inventory cost on-hand. As can be seen, the traditional Kanban system may be sensitive to demand changes but may not be equipped to address the demand changes without human intervention.

In addition, the Kanban system may also require that the replenishment time (e.g., time a supplier may take to provide the materials to replenish a bin) is the same as the one that has been utilized to calculate the replenishment loop size. However, suppliers may not always be able to adhere to the replenishment schedule as agreed upon by the consumer and the suppliers. In such a situation, the safety stock may be employed to address the shortage. However, if the suppliers continue to miss deadlines, safety stocks may be quickly depleted. Since a traditional Kanban system assumes a reliable replenishment time, stock-outs may occur.

To address the changes in demand and replenishment, the Kanban replenishment loop size may have to be resized. As discussing herein, loop size refers to the number of bins. Resizing may be a complex process that may require trained human resources. In an example, trained human resources may have to monitor and analyze the demands in order to determine the recent demand patterns. Further, trained resources may have to monitor the replenishment cycle to determine the replenishment trend. The process of monitoring may be tedious and may be susceptible to human errors, especially if the number of bins is large. Consider the situation wherein, for example, a typical manufacturing plant may have 2,000 to 5,000 different parts that are needed in order to produce a product. Each part may be associated with one or more bins. As a result, the number of bins that have to be monitored may become a large administrative task that requires several skilled workers.

Once the tedious and complex process of monitoring has occurred, the changes in the number of bins may be determined. In the situation described above, the storage of the vast number of parts may require a complex storage infrastructure to be established. As a result, changes to the number of bins may require changes to the complex storage infrastructure that requires time and space. In addition, the changes may have to be gradually integrated into a company's current Kanban system since most companies are unable to accommodate the changes quickly. Thus, inventory management in the Kanban system can be a large endeavor that becomes costly to maintain if demand changes result in constant resizing.

### SUMMARY OF INVENTION

The invention relates, in an embodiment, to a dynamic lean replenishment method for handling inventory management. The method includes performing analysis to determine a projected inventory stock. The analysis is performed in accordance with at least one of a synchronous mode and an asynchronous mode. In the synchronous mode, a computer is configured to perform the analysis to determine the projected inventory stock after consumption has occurred. The consumption is deemed to have occurred when a first bin of a plurality of bins is consumed and changes from a bin state of on-hand to the bin state of empty. In the asynchronous mode, the computer is configured to perform the analysis to determine the projected inventory stock after a preset time interval. The method also includes comparing the projected inventory stock to a safety stock to determine replenishment.

In another embodiment, the invention relates to a dynamic lean replenishment arrangement for handling inventory management. The arrangement includes a plurality of bins, each bin of the plurality of bins being associated with a bin state. The bin state includes on-hand, empty, and on-order. The arrangement also includes a computer for performing an analysis to determine a projected inventory stock. The analysis is performed in accordance with at least one of a synchronous mode and an asynchronous mode. In the synchronous mode, the computer is configured to perform the analysis to determine the projected inventory stock after consumption has occurred. The consumption is deemed to have occurred when a first bin of the plurality of bins is consumed and changed from the bin state of on-hand to the bin state of empty. In the asynchronous mode, the computer is configured to perform the analysis to determine the projected inventory stock after a preset time interval.

In yet another embodiment, the invention relates to an article of manufacture comprising a program storage medium having computer readable code embodied therein. The computer readable code is configured to handle inventory management. The article of manufacture includes computer readable code for performing analysis to determine a projected inventory stock. The analysis is performed in accordance with at least one of a synchronous mode and an asynchronous mode. In the synchronous mode, a computer is configured to perform the analysis to determine the projected inventory stock after consumption has occurred. The consumption is deemed to have occurred when a first bin of a plurality of bins is consumed and changes from a bin state of on-hand to the bin state of empty. In the asynchronous mode, the computer is configured to perform the analysis to determine the projected inventory stock after a preset time interval. The article of manufacture also includes computer readable code for comparing the projected inventory stock to a safety stock to determine replenishment.

In yet another embodiment, the invention relates to a dynamic lean replenishment method for handling inventory management. The method includes performing analysis to determine a reorder point. The analysis is performed in an asynchronous mode. In the asynchronous mode, the computer is configured to perform the analysis to determine the reorder point after a preset time interval. The method also includes comparing the reorder point to a current reorder point to determine replenishment.

In yet another embodiment, the invention relates to a dynamic lean replenishment arrangement for handling inventory management in a company. The arrangement includes a plurality of lot sizes. Each lot size of the plurality of lot sizes includes a set of lots. The arrangement also includes a computer for performing analysis to determine a reorder point. The analysis is performed in an asynchronous mode. In the asynchronous mode the computer is configured to perform the analysis to determine the reorder point after a preset time interval.

The above summary relates to only one of the many embodiments of the invention disclosed herein and is not intended to limit the scope of the invention, which is set forth in the claims herein. These and other features of the present invention will be described in more detail below in the detailed description of the invention and in conjunction with the following figures.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 shows a simple flow chart diagram illustrating the method for implementing the Kanban system.

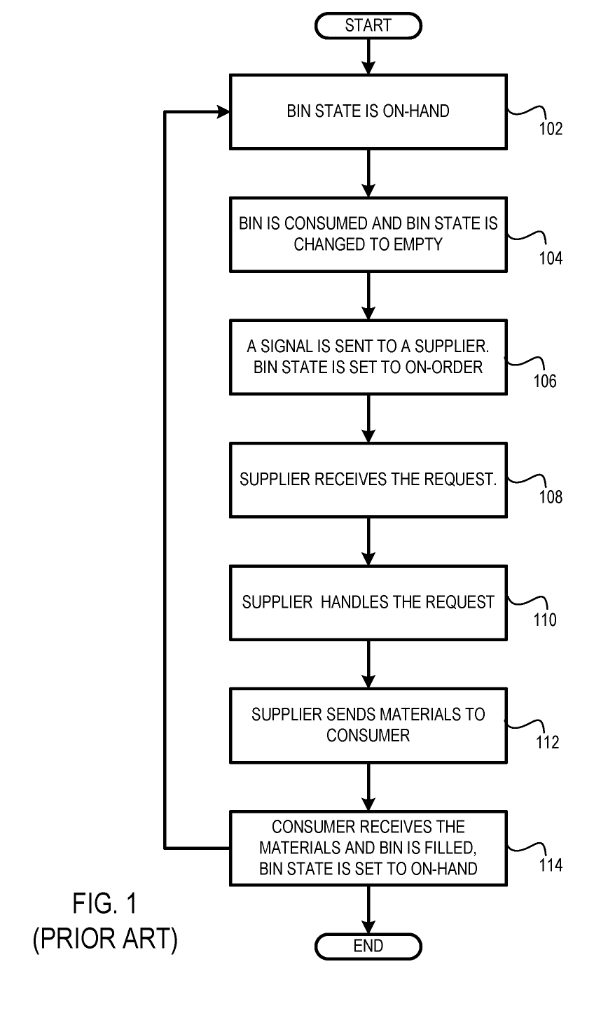

FIG. 2 is a simple diagram illustrating the different bin states in a traditional Kanban system.

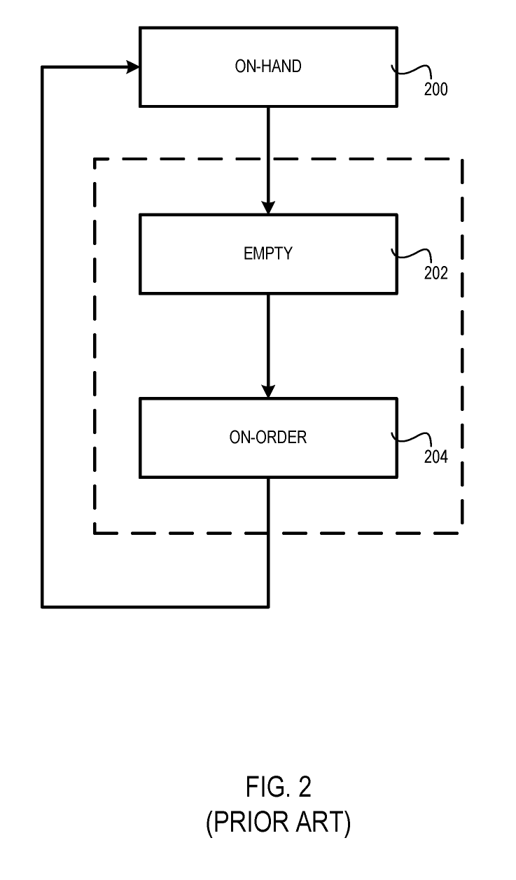

FIG. 3 shows, in an embodiment of the invention, a block diagram of a dynamic lean replenishment arrangement.

FIG. 4 shows, in an embodiment of the invention, a simple flow chart illustrating a dynamic lean replenishment method.

FIG. 5 shows, in an embodiment of the invention, simple diagram illustrating the different bin states in a dynamic lean replenishment arrangement.

FIG. 6 shows, in an embodiment of the invention, a simple flow chart illustrating the methods for performing analysis and calculating the projected inventory stock.

FIG. 7 shows, in an embodiment of the invention, an example of a flow chart illustrating how the dynamic lean replenishment method may be applied in an MRP system.

### DETAILED DESCRIPTION OF EMBODIMENTS

The present invention will now be described in detail with reference to a few embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

Various embodiments are described herein below, including methods and techniques. It should be kept in mind that the invention might also cover articles of manufacture that includes a computer readable medium on which computer-readable instructions for carrying out embodiments of the inventive technique are stored. The computer readable medium may include, for example, semiconductor, magnetic, opto-magnetic, optical, or other forms of computer readable medium for storing computer readable code. Further, the invention may also cover apparatuses for practicing embodiments of the invention. Such apparatus may include circuits, dedicated and/or programmable, to carry out tasks pertaining to embodiments of the invention. Examples of such apparatus include a general-purpose computer and/or a dedicated computing device when appropriately programmed and may include a combination of a computer/computing device and dedicated/programmable circuits adapted for the various tasks pertaining to embodiments of the invention.

In accordance with embodiments of the present invention, there is provided a dynamic lean replenishment arrangement and/or method for sustaining an optimal inventory level while maintaining a sufficient safety stock. Embodiment of the invention further provides a statistical method for analyzing the historical data in order to determine the projected inventory stock in order to determine the amount of inventory that may need to be replenished. As discussed herein, projected inventory stock refers to the amount of inventory that may need to be replenished in order to maintain the safety stock.

In one aspect of the invention, the inventor herein realized that the prior art Kanban system provides for a one-to-one replenishment. In the prior art, replenishment occurs as consumption occurs. As a result, replenishment may occur regardless of the rate of consumption resulting in inaccurate inventory level when demand pattern changes.

In one aspect of the invention, the inventor herein realized that replenishment may not have to occur immediately after consumption has occurred. Instead, historical data may be employed to project upcoming inventory needs thereby enabling replenishment to occur dynamically. Hence, by dynamically adjusting the replenishment amount, the inventors herein realized that daily fluctuations may be accommodated without being encumbered by the complex and expensive resizing method, which may be a complex and expensive method that may require time to be implemented.

In this document, various implementations may be discussed using an external inventory management system in which the suppliers are external suppliers. This invention, however, is not limited to an external inventory management system and may include an internal inventory management system. Instead, the discussions are meant as examples and the invention is not limited by the examples presented.

Also, in this document various implementations may be discussed using a synchronous dynamic lean replenishment arrangement and/or method. This invention, however, is not limited to a synchronous dynamic lean replenishment arrangement and/or method and may include an asynchronous dynamic lean replenishment arrangement and/or method. As discussed herein, a synchronous dynamic lean replenishment method refers to an inventory management system that is based on consumption. As also discussed herein, an asynchronous dynamic lean replenishment method refers to an inventory management system that is based on a set time interval. The discussions are meant as examples and the invention is not limited by the examples presented.

In an embodiment of the invention, projected inventory stock may be calculated based on historical demand trends and replenishment trends. Based on demand trends, projected consumption over the lead time may be calculated. Based on replenishment trends, the amount of replenished inventories within a lead time may be calculated. As discussed herein, lead time refers to the amount of time that may be required in order to receive an order.

In an embodiment, projected consumption over the lead time may be determined based on a rate of consumption and a lead time. As discussed herein, rate of consumption refers to the amount of inventory that may be consumed in a given period of time. To calculate either rate of consumption or lead time, different statistical methods may be employed. Examples include, but are not limited to, a moving average method, a weighted moving average method, and a simple linear regression method.

In an embodiment, the amount of replenished inventories may be based on the amount of inventory that is expected to be replenished within the lead time period. To determine the amount, in an embodiment, an order method may be employed in which the amount on-order represents the amount of replenishment inventories that may be received during the lead time. In another embodiment, a rule-based order method may be employed in which the amount of replenishment inventories may be based on a set of system rules as defined by a consumer and suppliers.

In an embodiment, the projected inventory stock at the end of lead time may be calculated by deducting consumption over the lead time and adding the amount of replenished inventories to current inventory on-hand. With a projected inventory stock, the system is able to compare the projected inventory stock against a safety stock level. Different actions may occur depending upon the comparison.

In an embodiment, a projected inventory stock that is greater than or equal to the safety stock may require that no replenishment signal to be sent to a supplier. Unlike the prior art, a replenishment signal is not sent unless the projected inventory stock is lower than the safety stock thus preventing unnecessary high inventory carrying cost.

In an embodiment, if the projected inventory stock is less than the safety stock, a replenishment signal may be sent. In an embodiment, a replenishment signal may not be sent if an empty bin is not available. In another embodiment, the number of replenishment signals that may be sent may be based on the amount that is needed in order to make the projected inventory stock equal to the safety stock.

The dynamic lean replenishment arrangement and/or method, in an embodiment, may ensure an optimum level of inventory without incurring stock out. Unlike the traditional Kanban system, which is best applied in a consistent demand environment, the dynamic lean replenishment arrangement may accommodate fluctuating demands.

The features and advantages of the present invention may be better understood with reference to the figures and discussions that follow.

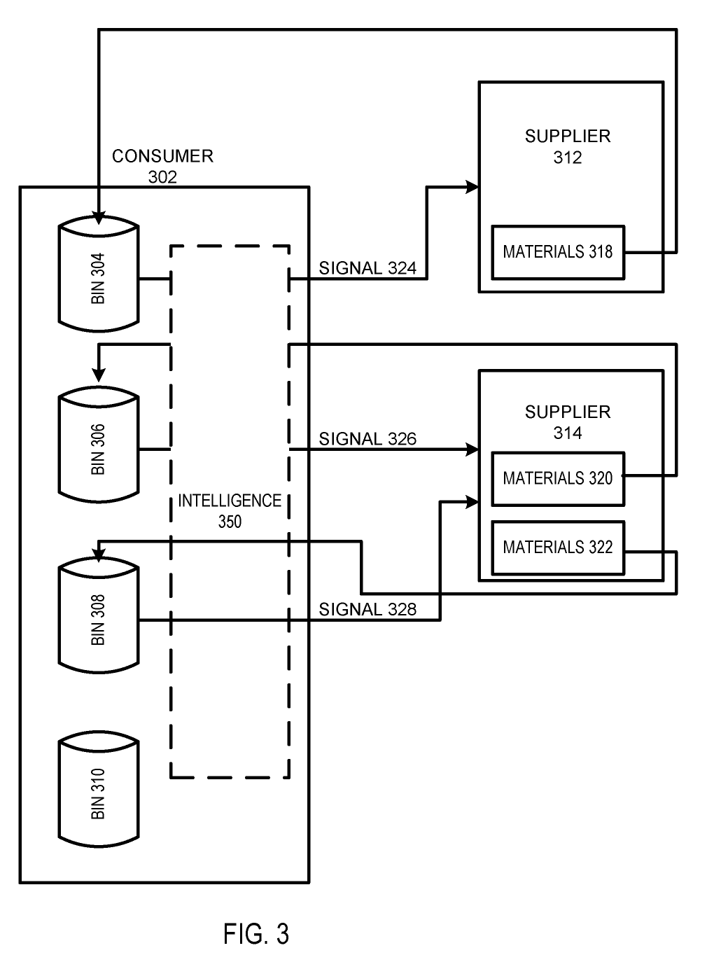

FIG. 3 shows, in an embodiment of the invention, a block diagram of a dynamic lean replenishment arrangement. A consumer 302 may include a plurality of bins (e.g., bins 304, 306, 308, and 310). Bins 304, 306, and 308 may represent the bins that are currently being employed by company 302. Bin 310 may represent an additional empty bin that company 302 may have ready in order to accommodate fluctuation.

In an embodiment, the number of bins that a consumer may have available may depend upon an initial analysis of the consumer's historical demand trend. In an example, a consumer's demand historical trend has shown that on average 10 bins may be sufficient to handle the daily demands. However, the demand historical trend has also shown that now and then 30 bins may be required in order to handle the fluctuation in demands. As a result, the consumer may place 30 bins on its company floor and fill only 10 bins. The extra 20 bins may remain empty until changes in demand require additional bins to be filled. This method of anticipating demand without carrying the inventory cost is a cost effective method of addressing fluctuation in demands that minimizes the possibility of a stock-out and/or the possibility of having to constantly resize the replenishment loop size.

Consider the situation wherein, for example, bin 304 has been consumed. The dynamic lean replenishment system may include an intelligence 350 that is capable of performing analysis and calculating the projected inventory stock. In an embodiment, intelligence 350 may be a computer system that may include a database capable of storing consumption events and receipt events of replenished materials. As discussed herein, projected inventory stock refers to an amount of inventory stock that substantially minimizes inventory carrying cost but prevent stock-out.

If intelligence 350 determines that bin 304 may have to be replenished in order to meet the projected inventory stock, then a signal 324 may be sent to a supplier 312. Upon receiving the signal, supplier 312 may produce/provide materials 318, which may be sent to consumer 302 to replenish bin 304.

However, a consumed bin may not always require replenishment to occur. Consider the situation wherein, for example, bin 306 has been consumed. However, upon analysis, the projected inventory stock has been determined to be met by the consumer's current inventory stock. As a result, even though bin 306 has been emptied, the bin does not have to be replenished.

Consider another situation wherein, for example, more than one bin may have to be replenished. In an example, bin 308 has been consumed. Upon analysis, two bins may have to be replenished in order to meet the projected inventory stock requirement. Intelligence 350 may send a signal 328 to a supplier 314 to replenish bin 308 with materials 322. In addition, intelligence 350 may identify a second bin (e.g., bin 306) that may also have to be replenished. Thus, a signal 326 may have to be sent to supplier 314 to replenish bin 306 with materials 320.

FIG. 3 shows a synchronous dynamic lean replenishment arrangement. However, the dynamic lean replenishment arrangement may also be implemented asynchronously. In an example, instead of performing an analysis each time when consumption occurs, analysis may be performed at preset time intervals.

The dynamic lean replenishment arrangement shown in FIG. 3 is an example of how the arrangement may be implemented in order to accommodate the dynamic changes in demand. Instead of automatically replenishing each emptied bin, the dynamic lean replenishment arrangement allows for analysis to be performed in a timely manner in order to calculate a projected inventory stock and determine the required number of bins that may have to be replenished. With the dynamic lean replenishment arrangement, inventory carrying cost may be substantially minimized and stock-outs may be prevented.

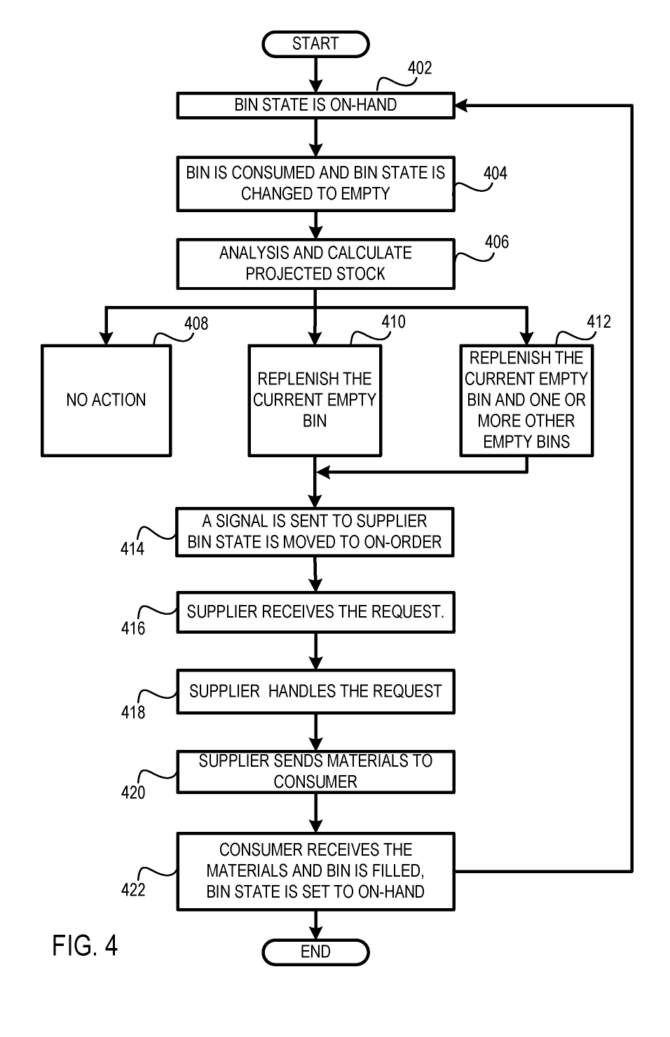

FIG. 4 shows, in an embodiment of the invention, a simple flow chart illustrating a dynamic lean replenishment method.

At a first step 402, a bin state is on-hand. In an example, the bin is full of materials and consumption has not occurred.

At step 404, the bin is consumed and the bin state is changed to empty. Unlike the prior art, an empty state may not require an immediate signal to be sent to the supplier for replenishment. Instead, analysis may be performed in order to determine the amount of replenishment that may occur.

At step 406, analysis may be performed and projected inventory stock may be calculated. In an embodiment, the analysis may be performed automatically by a computer system, which may store consumption events and receipt events of replenished materials. The method for analyzing and calculating projected inventory stock is discussed in details in the later figures.

Once analysis has been performed and the projected inventory has been determined, three alternatives (as shown in steps 408, 410, and 412) are available, in an embodiment.

The method may determine that, at step 408, no action is needed since the projected inventory stock has been determined to be at a sufficient level (enough safety stock to handle unexpected spikes). In an example, the bin that is currently in an empty state (as described in step 404) is not immediately replaced because the company has sufficient safety stock and/or demand may be currently declining.

Alternatively, at step 41O, the method may determine that the current empty bin (from step 404) may need to be replenished.

Alternatively, at a next step 412, the method may determine that not only does the current empty bin (from step 404) need to be replenished but one or more empty bins may also need to be replenished since demand is rising and/or the safety stock is insufficient.

If the method determines that either step 410 or step 412 best describes the consumer's current situation, at step 414, one or more replenishment signals may be sent to a supplier. Upon sending the signal, the bin that is impacted is changed from an empty state to an on-order state.

At a next step 416, the supplier receives the request.

At a next step 418, the supplier handles the request.

At a next step 420, the supplier sends the materials to the consumer.

At a last step 422, the consumer receives the materials and one or more bins are filled. Once the bin has been replenished, the bin state may be changed from on-order to on-hand.

The method described in steps 402 to 422 is an iterative process that occurs as bins are consumed.

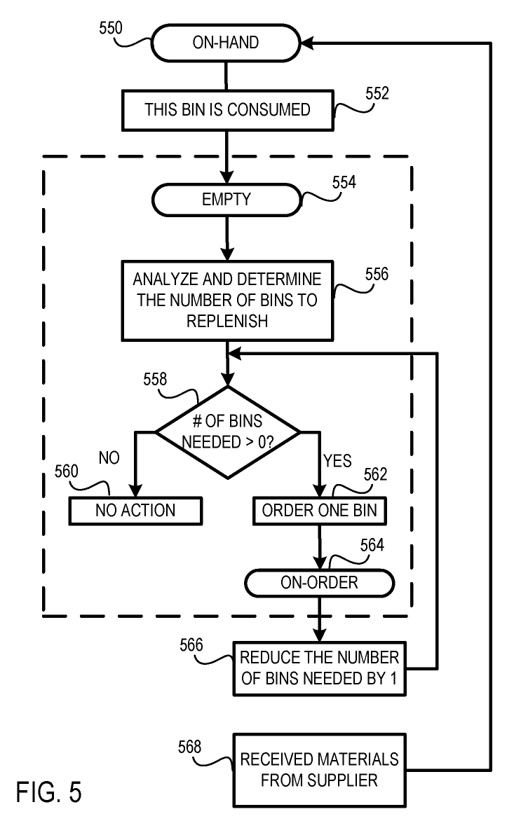

FIG. 5 shows, in an embodiment of the invention, simple diagram illustrating the different bin states in a dynamic lean replenishment system.

At state 550, the bin has a state of on-hand. In an example, the bin has been filled and consumption has not occurred.

At step 552, the bin is consumed.

At state 554, the bin state is changed from on-hand to empty.

At a next step 556, analysis is performed. With analysis, the projected inventory stock may be calculated and the number of additional bins required is identified. As aforementioned, more details will be provided for the analysis in later figures.

If at a next step 558, the number of additional bins that may have to be replenished is zero or less, then at a next step 560, no action may be needed and the bin may remain empty.

However, if at next step 558, the number of additional bins that have to be replenished is greater than zero, then at step 562, an order is placed with a supplier, which may include sending a signal to the supplier requesting for a bin to be refilled.

Once the order has been placed, at step 564, the bin state is changed from empty to on-order.

At step 566, the number of bins needed may be reduced by one.

The methods for placing an order with a supplier as described in steps 558 to 566 may be an iterative process until the number of bins needed to be replenished based on the projected inventory stock number has been met. In an embodiment, the dynamic lean replenishment system may enable more than one bin to be ordered since additional empty bins are available. In an example, empty bins may be available due to bins that may have been previously consumed but not replenished due to the projected inventory stock requirement at the time. In another example, the company may have set aside 30 bins but may not have needed to fill more than 10 bins. However, with the current projected inventory stock requirement, one or more of the currently empty 20 bins may be replenished.

At step 568, the materials are received by the consumer and the bin is refilled. The method described in steps 550 to 568 is an iterative process and may be employed to accommodate daily fluctuations.

FIG. 4 and 5 are examples of the dynamic lean replenishment method. As can be seen, the method may not automatically require a consumed bin to be replenished. Instead, the method may implement an intelligence that is capable of analyzing a company's demand pattern to determine when replenishment may need to occur.

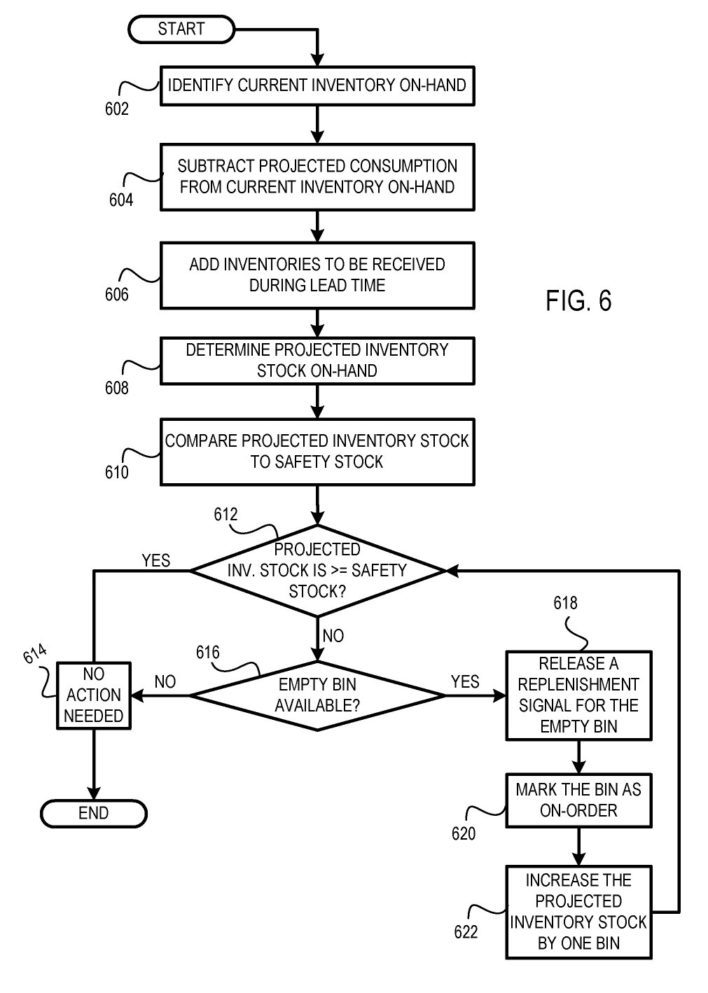

FIG. 6 shows, in an embodiment of the invention, a simple flow chart illustrating an example of how analysis and calculating the projected inventory stock (as shown in steps 406 and 556) may be performed.

At step 602, the method identifies the current inventory on-hand. Consider the situation wherein, for example, a company has 10 bins available on-hand. Once a bin has been consumed, the system may check a database, for example, to determine how many bins are available. In an embodiment, in an asynchronous dynamic lean replenishment arrangement, instead of performing analysis each time consumption occurs, analysis may be performed at a preset time interval.

At a next step 604, projected consumption may be subtracted from the current inventory on-hand. As discussed herein, projected consumption refers to the amount of inventories (e.g., bins) that may be consumed during the lead time. To determine projected consumption, a rate of consumption and a lead time may be calculated.

In an embodiment, a rate of consumption may be based on a moving average method. In an example, the company may determine that the rate of consumption is based on an average of the last 10 days. For example, during the last 10 days, 30 bins may have been consumed. Thus, an average of 3 bins has been consumed each day. The rate of consumption is then compared to the maximum and minimum rates of consumption. The maximum and minimum rates of consumption may be employed in order to prevent an indefinite increase in inventory and/or a drop in inventory level that may cause stock-out. Assume in this example, that the maximum rate of consumption is 4 bins per day and the minimum rate of consumption is 1 bin per day. Since the rate of consumption (e.g., 3 bins) is between the minimum and maximum rates of consumption (e.g., 1 bin and 4 bins, respectively), the rate of consumption may be set to the calculated average rate of consumption. However, if the rate of consumption is greater than the maximum rate of consumption, then the rate of consumption may be set to the maximum rate of consumption (e.g., 4 bins). Likewise, if the rate of consumption is less than the minimum rate of consumption, then the rate of consumption may be set to the minimum rate of consumption (e.g., 1 bin).

The moving average method is a sliding window method that takes into account changing conditions but at the same time gives little or no weight to consumption that has occurred beyond a defined time period. In an example, if the initial time period of analysis is from June 1 to June 14, the next day analysis may be from June 2 to June 15. Thus, only the most recent consumption data may be employed in calculating the moving average.

In an embodiment, a weighted moving average method may be employed instead of a moving average method. The weighted moving average method is similar to the moving average method except different weights may be applied to the data depending upon relevancy (e.g., more recent data vs. less recent data).

In another embodiment, a rate of consumption may be calculated based on a simple linear regression method. In this method, consumption over a defined time period may be collected and plotted on a graph. Linear regression may occur in which the data plotted may be approximated in order to determine a trend line. A slope and intercept may be calculated based on the plotted historical data. With the slope and intercept, a projected rate of consumption may be determined. The slope and intercept method is well-known to those skilled in the art. Thus, no further discussion will be provided.

The three methods described above are only examples of the methods that may be employed to calculate the rate of consumption.

Besides the rate of consumption, the lead time may also be calculated. As discussed herein, a lead time refers to the time interval an order may be fulfilled by a supplier. In an embodiment, one method for determining the lead time is based on a set value. In an example, a set value of 6 days may have been established as the lead time. Thus, the company may assume that an order to fill an empty bin may take 6 days to be received.

In another embodiment, a method for calculating the lead time may be based on historical replenishment trend. In an example, a moving average may be employed to calculate the historical lead time. In an example, the company may determine that lead time may be based on the average replenishment time period for the last 10 orders. For example, during the last 10 orders, 50 days may have been required to receive all 10 orders. Thus, on average, a shipment may be received in 5 days from the date of order. Although days are being employed, time interval may be expressed in hours, minutes, weeks, and the likes. The time interval may change depending upon the consumer's needs.

Similar to the rate of consumption, the moving average may be weighted. In an example, different weights may be applied to the data depending upon relevancy (e.g., more recent data vs. less recent data).

In another embodiment, the lead time may be calculated based on a simple linear regression method. In this method, replenishment time period for a predetermined number of orders may be collected and plotted on a graph. Linear regression may occur in which the data plotted may be approximated in order to determine a trend line. A slope and intercept may be calculated based on the plotted historical data. With the slope and intercept, a projected lead time may be determined.

Once the rate of consumption and the lead time have been determined, projected consumption over the lead time may be calculated. In an example, the rate of consumption is 3 bins per day and the lead time is 5 days. To calculate the projected consumption, the rate of consumption may be multiplied by the lead time.

Projected consumption=Rate of consumption×Lead time

Projected consumption=3×5

Projected consumption=15 bins Equation 1

Equation 1 above shows an example of a projected consumption calculation. Based on the calculation, 15 bins may be consumed within the next 5 days. Thus, the amount to be consumed within the lead time is the calculated projected consumption.

In an embodiment, same or different statistical method may be employed in calculating the rate of consumption and the lead time. In an example, if the weighted moving average method has been employed to calculate the rate of consumption, then a simple moving average method may be employed to calculate the lead time.

At a next step 606, the inventory (e.g., bins) that may be received during the lead time may be added to current inventory on-hand. Different methods may be employed to determine the amount of replenished inventory. In an embodiment, the order method may be employed. With the order method, the amount of replenished inventory that is currently on-order is assumed to be received by the company within the lead time. In an example, if 16 bins are currently on-order, then the amount of replenished inventory is 16 bins.

In another embodiment, a rule-based order method may be employed. With the rule-based order method, the amount of replenished inventory may be based on a set of system rules, which may be dependent upon when an order may have been placed with a supplier. In an example, if an order is placed before a certain date then the order may be fulfilled within a certain number of days and therefore, may be received within the lead time. However, if an order is placed after a certain date or time then the order may not be fulfilled immediately and may not be received by the company within the lead time. In an example, if an order is placed with a supplier before Wednesday, then the order will be handled on Thursday. However, if an order is placed after Wednesday, then the order will not be handled until next Monday. Consider the situation wherein, for example, of the 16 bins on-order, only 9 bins may have been ordered prior to Wednesday. The rule-based order method, in an embodiment, may be pre-set based on agreed upon rules established by the consumer and suppliers.

At step 608, a projected inventory stock on-hand is determined. In calculating the projected inventory stock on-hand, the current inventory on-hand is reduced by projected consumption over the lead time and increased by amount of replenished inventory over the same lead time. Equation 2 below shows how projected inventory stock on-hand may be calculated.

Projected inventory stock on-hand=Current inventory on-hand−projected consumption+Amount of replenished inventory

Projected inventory stock on-hand=10−15+9

Projected inventory stock on-hand=4 bins Equation 2

At step 610, the projected inventory stock on-hand may be compared to the safety stock. In an embodiment, safety stock may be based on an absolute quantity. In an example, the safety stock may be 6 bins. In another embodiment, safety stock may be based on a dynamic quantity. In an example, if a bin is consumed every day and three days worth of safety stock is needed, 3 bins are needed as safety stock. In another example, if 2 bins are consumed every day and 3 days of safety stock is needed, then 6 bins are needed.

At step 612, if the projected inventory stock is greater than the safety stock, the method may proceed to step 614, in which no action (e.g., no addition bin may need to be ordered) may be needed. In an example, if the projected inventory stock is 5 bins and the safety stock is 3 bins, then a replenishment signal may not be sent.

However, if the projected inventory stock is less than the safety stock the method may proceed to the next step, 616, to determine if an empty bin is available. In an example, if the projected inventory stock is 5 bins and the safety stock is 6 bins, then 1 bin may need to be replenished.

At step 616, if no empty bin is available, then the method may proceed to step 614 and no bin may be replenished. This safeguard may be implemented in order to prevent an indefinite increase in the number of bins. In some cases new bins may be created as needed.

However, if an empty bin is available, then at step 618, a replenishment signal may be released for the empty bin and an order is placed with a supplier in order to fill the empty bin.

At step 620, the empty bin is marked as on-order. In an example, the bin state may be changed from empty to on-order.

At step 622, the amount of projected inventory stock on-hand may be increased by 1 bin.

The method described in steps 612 to 622 is an iterative method and may be performed until the amount of projected inventory stock is greater than or equal to the safety stock.

The method described in FIG. 6 may provide a more analytical and more precise method for determining replenishment in a dynamic environment. With this method, excess inventory on-hand may be substantially reduced and safety stock may be prevented from inadvertently reduced. Furthermore, since the dynamic lean replenishment method may be performed either at a preset time interval or when consumption occurs, any data errors that have been found and corrected is quickly addressed at the next analysis and calculation.

Although the embodiments have been discussed in relation to the Kanban system, the dynamic lean replenishment arrangement and methods may also be applied to an MRP system (material requirements planning system). Traditionally, the MRP system has been employed in forecasting. Thus, in an MRP system, the desired inventory level may be current inventory on-hand plus what may be on order. If the desired inventory level is less than a reorder point (i.e., the point at which the amount of inventory on-hand plus what is on order is considered below the minimum amount of inventory that a company should maintain), an order may be placed with a supplier. Further, the amount that is ordered may be tied to an economic order quantity. An economic order quantity is based on a calculation in which the amount ordered is optimized while minimizing the amount of work that may be associated with reordering.

The dynamic lean replenishment arrangement and methods may be applied in the MRP system similar to that of the Kanban system. However, instead of a bin, lot size may be employed. Also, instead of safety stock, a reorder point indicating the optimum level for sum of current inventory and materials on order may be employed.

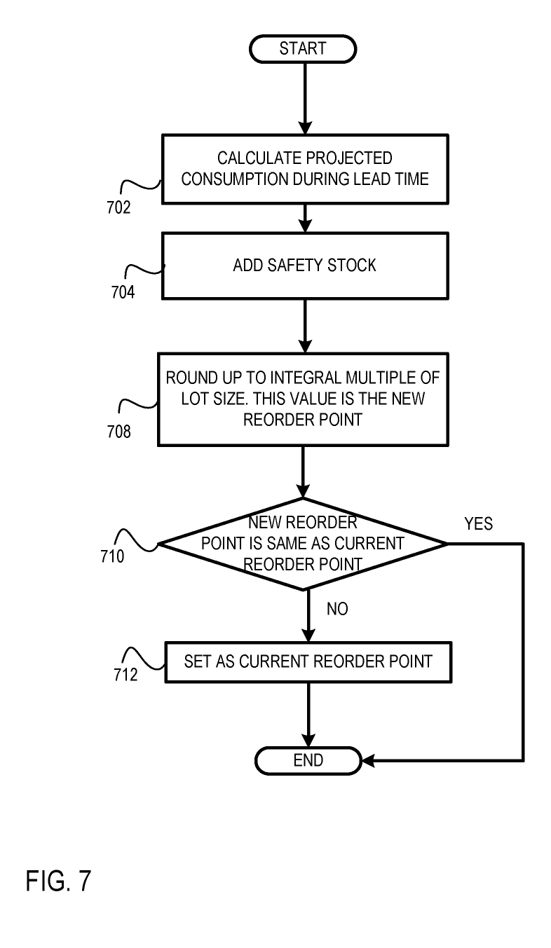

FIG. 7 shows, in an embodiment, an example of a flow chart illustrating how the dynamic lean replenishment method may be applied in an MRP system.

Consider the situation wherein, for example, a company has a desired safety stock of 2 lot sizes, each lot size having 24 lots. Also, the reorder point is 192 lots.

At step 702, analysis may be performed to calculate the projected consumption during the lead time. Similar to the Kanban system, analysis may be performed through various statistical methods, including but are not limited to, the moving average method, the weighted moving average method, and the like. In this example, assume that 20 lots are consumed per day and the lead time is 8 days. Thus, the projected consumption over the lead time is 160 lots.

At step 704, the desired safety stock amount is added to the amount calculated in step 702 to calculate the estimated reorder point. In other words, the desired safety stock amount (e.g., 48 lots) may be added to the projected consumption during the lead time. In an example, the sum of desired safety stock amount with projected consumption is 208 lots.

At step 708, the amount calculated in step 704 is rounded up to an integral multiple of lot size. In an example, since 1 lot size is equal to 24 lots, the value of 208 lots is only equal to 8.66 lot sizes. Since reorder is based on lot size, 8.66 lot sizes may have to be rounded up to 9 lot sizes, which is the equivalent of 216 lots. This value may be taken as the desired reorder point.

At step 710, the desired reorder point may be compared to current reorder point set in MRP system. In an example, the current reorder point is 192 lots (i.e., 8 lot sizes) and the desired reorder point is 216 lots (i.e., 9 lot sizes). If the desired value is not the same as the current value, the method may proceed to a step 712.

At a next step 712, the current value of reorder point in the MRP system may be replaced with the desired value calculated in step 708. This value may establish a new reorder point (i.e., updated reorder point) based on consumption analysis. In an example, based on consumption analysis, the reorder point may be updated and changed from 192 lots to 216 lots.

The method described in steps 702 to 712 is an iterative method and may be performed at predetermined intervals of time to adjust current reorder point as frequently as possible.

As can be appreciated from the forgoing, one or more embodiments of the present invention provide a dynamic lean replenishment arrangement. By implementing dynamic lean replenishment arrangement, resizing may be substantially eliminated since historical trends have been analyzed in order to determine the maximum number of bins that may be potentially utilized by a company. As a result, the dynamic lean replenishment arrangement minimizes the impact demand fluctuations and/or suppliers' replenishment capability may have on the company. Also, the dynamic lean replenishment arrangement provides for a cost effective method of accommodating changes without requiring the employment of expensive trained labor resources.

While this invention has been described in terms of several preferred embodiments, there are alterations, permutations, and equivalents, which fall within the scope of this invention. Also, the title, summary, and abstract are provided herein for convenience and should not be used to construe the scope of the claims herein. It should also be noted that there are many alternative ways of implementing the methods and apparatuses of the present invention. Although various examples are provided herein, it is intended that these examples be illustrative and not limiting with respect to the invention. Further, in this application, a set of “n” items refers zero or more items in the set. It is therefore intended that the following appended claims be interpreted as including all such alterations, permutations, and equivalents as fall within the true spirit and scope of the present invention.

What is claimed is:

1. A dynamic lean replenishment method for handling inventory management, comprising:
performing analysis to determine a projected inventory stock, said analysis being performed in accordance with at least one of a synchronous mode and an asynchronous mode,
wherein in said synchronous mode a computer is configured to perform said analysis to determine said projected inventory stock after consumption has occurred, said consumption is deemed to have occurred when a first bin of a plurality of bins is consumed and changes from a bin state of on-hand to said bin state of empty,
wherein in said asynchronous mode said computer is configured to perform said analysis to determine said projected inventory stock after a preset time interval; and comparing said projected inventory stock to a safety stock to determine replenishment.

2. The dynamic lean replenishment method of claim 1 wherein said projected inventory stock is calculated by determining a projected consumption and an amount of replenished inventory within a lead time,
wherein said projected consumption is calculated by determining a rate of consumption and said lead time,
wherein said amount of replenished inventory is determined by at least one of an order method and a rule-based method.

3. The dynamic lean replenishment method of claim 2 wherein a statistical method is employed to calculate said rate of consumption and said lead time,
wherein said rate of consumption being calculated from analyzing historical consumption data,
wherein said lead time being calculated from analyzing said historical replenishment data.

4. The dynamic lean replenishment method of claim 3 wherein said statistical method includes a moving average method.

5. The dynamic lean replenishment method of claim 3 wherein said statistical method includes a weighted moving average.

6. The dynamic lean replenishment method of claim 3 wherein said statistical method includes a simple linear regression method.

7. The dynamic lean replenishment method of claim 2 wherein said order method including accounting for each bin of said plurality of bins that is in said bin state of on-order.

8. The dynamic lean replenishment method of claim 2 wherein said rule-based order method including accounting for each bin of said plurality of bins that is in said bin state of on-order and said accounting is based on a set of system rules, said set of system rules defining how an order is fulfilled.

9. The dynamic lean replenishment method of claim 1 wherein no action is performed when said projected inventory stock is at least equal to said safety stock.

10. The dynamic lean replenishment method of claim 1 wherein an action is performed when said projected inventory stock is less than said safety stock, said action including identifying a bin in said bin state of empty.

11. The dynamic lean replenishment method of claim 10 wherein no action is performed when said bin in said bin state of empty is unavailable.

12. The dynamic lean replenishment method of claim 10 wherein a first replenishment signal is sent when said bin in said bin state of empty is available

13. The dynamic lean replenishment method of claim 12 wherein a second replenishment signal is sent when said projected inventory stock remains less than said safety stock after said first replenishment signal has been sent.

14. The dynamic lean replenishment method of claim 1 wherein said analysis is being performed in accordance with said synchronous mode.

15. The dynamic lean replenishment method of claim 1 wherein said analysis is being performed in accordance with said asynchronous mode.

16. A dynamic lean replenishment arrangement for handling inventory management, comprising:
a plurality of bins, each bin of said plurality of bins being associated with a bin state, said bin state including on-hand, empty, and on-order; and
a computer for performing an analysis to determine a projected inventory stock, said analysis being performed in accordance with at least one of a synchronous mode and an asynchronous mode,
wherein in said synchronous mode said computer is configured to perform said analysis to determine said projected inventory stock after consumption has occurred, said consumption is deemed to have occurred when a first bin of said plurality of bins is consumed and changed from said bin state of on-hand to said bin state of empty,
wherein in said asynchronous mode said computer is configured to perform said analysis to determine said projected inventory stock after a preset time interval.

17. The dynamic lean replenishment arrangement of claim 16 wherein said projected inventory stock is calculated by determining a projected consumption and an amount of replenished inventory within a lead time,
wherein said projected consumption is calculated by determining a rate of consumption and said lead time,
wherein said amount of replenished inventory is determined by at least one of an order method and a rule-based method.

18. The dynamic lean replenishment arrangement of claim 17 wherein a statistical method is employed to calculate said rate of consumption and said lead time,
wherein said rate of consumption being calculated from analyzing historical consumption data,
wherein said lead time being calculated from analyzing said historical replenishment data,
wherein said statistical method including a moving average method, a weighted moving average, and a simple linear regression method.

19. The dynamic lean replenishment arrangement of claim 17 wherein said order method including accounting for said each bin of said plurality of bins that is in said bin state of on-order.

20. The dynamic lean replenishment arrangement of claim 17 wherein said rule-based order method including accounting for said each bin of said plurality of bins that is in said bin state of on-order and said accounting is based on a set of system rules, said set of system rules defining how an order is fulfilled.

21. The dynamic lean replenishment arrangement of claim 16 wherein said projected inventory stock is compared to a safety stock to determine said replenishment,
wherein no action is performed when said projected inventory stock is at least equal to said safety stock,
wherein an action is performed when said projected inventory stock is less than said safety stock, said action including identifying a bin in said bin state of empty.

22. The dynamic lean replenishment arrangement of claim 21 wherein no further action is performed when said bin in said bin state of empty is unavailable.

23. The dynamic lean replenishment arrangement of claim 21 wherein a first replenishment signal is sent when said bin in said bin state of empty is available

24. The dynamic lean replenishment arrangement of claim 23 wherein a second replenishment signal is sent when said projected inventory stock remains less than said safety stock after said first replenishment signal has been sent.

25. The dynamic lean replenishment arrangement of claim 16 wherein said analysis is being performed in accordance with said synchronous mode.

26. The dynamic lean replenishment arrangement of claim 16 wherein said analysis is being performed in accordance with said asynchronous mode.

27. An article of manufacture comprising a program storage medium having computer readable code embodied therein, said computer readable code being configured to handle inventory management, comprising:
computer readable code for performing analysis to determine a projected inventory stock, said analysis being performed in accordance with at least one of a synchronous mode and an asynchronous mode,
wherein in said synchronous mode a computer is configured to perform said analysis to determine said projected inventory stock after consumption has occurred, said consumption is deemed to have occurred when a first bin of a plurality of bins is consumed and changes from a bin state of on-hand to said bin state of empty,
wherein in said asynchronous mode said computer is configured to perform said analysis to determine said projected inventory stock after a preset time interval; and
computer readable code for comparing said projected inventory stock to a safety stock to determine replenishment.

28. The article of manufacture of claim 27 wherein said projected inventory stock is calculated by determining projected consumption and amount of replenished inventory within a lead time,
wherein said projected consumption is calculated by determining a rate of consumption and said lead time,
wherein said amount of replenished inventory is calculated by determining at least one of an order method and a rule-based method,
wherein said order method including accounting for each bin of said plurality of bins that is in said bin state of on-order,
wherein said rule-based order method including accounting for each bin of said plurality of bins that is in said bin state of on-order and said accounting is based on a set of system rules, said set of system rules defining how an order is fulfilled.

29. The article of manufacture of claim 28 wherein a statistical method is employed to calculate said rate of consumption and said lead time,
wherein said rate of consumption being calculated from analyzing historical consumption data,
wherein said lead time being calculated from analyzing said historical replenishment data,
wherein said statistical method including a moving average method, a weighted moving average, and a simple linear regression method.

30. The article of manufacture of claim 27 further comprising computer readable code for handling replenishment, said handling including
performing no action if said projected inventory stock is at least equal to said safety stock,
performing an action if said projected inventory stock is less than said safety stock, said action including identifying a bin in said bin state of empty, and
if said bin in said bin state of empty is unavailable, performing no additional action,
if said bin in said bin state of empty is available, sending a first replenishment signal, and sending a second replenishment signal if said projected inventory stock remains less than said safety stock after said first replenishment signal has been sent.

31. A dynamic lean replenishment method for handling inventory management, comprising:
performing analysis to determine a reorder point, said analysis being performed in an asynchronous mode,
wherein in said asynchronous mode said computer is configured to perform said analysis to determine said reorder point after a preset time interval; and
comparing said reorder point to a current reorder point to determine replenishment.

32. The dynamic lean replenishment method of claim 31 wherein said reorder point is calculated by determining a projected consumption during a lead time.

33. The dynamic lean replenishment method of claim 32 wherein said projected consumption is calculated by performing a statistical analysis of historical consumption data, said statistical analysis including a moving average method, a weighted moving average, and a simple linear regression method.

34. The dynamic lean replenishment method of claim 32 wherein a safety stock is added to said projected consumption during said lead time to calculate an estimated reorder point.

35. The dynamic lean replenishment method of claim 34 wherein said estimated reorder point is rounded up to an integral multiple of lot size to generate a reorder point.

36. The dynamic lean replenishment method of claim 35 wherein said reorder point replaces said current reorder point.

37. A dynamic lean replenishment arrangement for handling inventory management in a company, comprising:
a plurality of lot sizes, each lot size of said plurality of lot sizes including a set of lots; and
a computer for performing analysis to determine a reorder point, said analysis being performed in an asynchronous mode,
wherein in said asynchronous mode said computer is configured to perform said analysis to determine said reorder point after a preset time interval.

38. The dynamic lean replenishment method of claim 37 wherein said reorder point is calculated by determining a projected consumption during a lead time.

39. The dynamic lean replenishment method of claim 38 wherein said projected consumption is calculated by performing a statistical analysis of historical consumption data, said statistical analysis including a moving average method, a weighted moving average, and a simple linear regression method.

40. The dynamic lean replenishment method of claim 38 wherein a safety stock is added to said projected consumption during said lead time to calculate an estimated reorder point.

41. The dynamic lean replenishment method of claim 40 wherein said estimated reorder point is rounded up to an integral multiple of lot size to generate a reorder point.

42. The dynamic lean replenishment method of claim 41 wherein said reorder point is compared to a current reorder point, wherein said reorder point replacing said current reorder point if said current reorder point is different from said reorder point.
